(19) United States
(12) Patent Application Publication
(10) Pub. No.: US 2014/0152016 A1
(43) Pub. Date: Jun. 5, 2014

(54) ATMOSPHERIC TRANSDUCTION SYSTEM

(71) Applicant: JAMES EDWARD JENNINGS, SUPERIOR, CO (US)

(72) Inventor: JAMES EDWARD JENNINGS, SUPERIOR, CO (US)

(21) Appl. No.: 13/692,121

(22) Filed: Dec. 3, 2012

(51) Int. Cl. H02N 11/00; F03D 9/00

(52) U.S. Cl. CPC H02N 11/002; F03D 9/003
USPC 290/55; 310/308

(57) ABSTRACT

Atmospheric Transduction System including a Power Frequency broadcast station, a receiver, and a network. The Power Frequency broadcast station includes a transmitter and a computer server. The receiver is in communication with the Power Frequency broadcast transmitter and also includes a user interface for receiving user input commands comprising a request for information from the Power Frequency broadcast station. The receiver is configured to establish a two-way communication path between the receiver and the Power Frequency broadcast transmitter. The network is in communication with the transducer, controller and the receiver for exchanging information therebetween. In response to oscillation translation and/or rotation of the electronic transducer, portions of forces induced by the mass are transferred to the piezoelectric elements. Electrical energy output by these piezoelectric elements is received in a power controller and can be applied to the battery as self charging. The piezoelectric transducer includes a conductive rotor and bearings, at least one of them incorporating a vibrator of mechanical oscillation, having a piezoelectric transducer converting mechanical vibrations into electric power.

### CROSS REFERENCE TO RELATED APPLICATIONS

NONE

### BACKGROUND OF THE INVENTION

### Field of the Invention

Self-propelled travel is a type of recreational adventure travel using human powered transport. This includes non-motorized machines such as a bicycle or skateboard. It is in contrast to traveling in a powered vehicle (such as an automobile) as in that case it is the vehicle which powers itself. Self-propelled travel is used to travel short distances or even for much longer distances such as bicycle touring. Self propelled describes something that moves, progresses or acts on its own power without needing outside help. Leonardo da Vinci's 1478 Self-Propelled Car: It was more than 500 years ago, however—sometime around the year 1478 to be more or less specific—when Leonardo drew out his plans for the world's first self-propelled vehicle. Experts originally believed two leaf springs, the simplest form of the spring typically used for automotive suspensions, somehow powered the vehicle. Closer inspection eventually revealed the power came from bigger, coiled springs located in tambours, cylindrical drum-like casings, inside the car's frame. The machine works like a robot or a wind-up toy simply by rotating the wheels opposite of their intended direction, which winds up the springs inside and gives it power. Self propulsion (of a vehicle) provided with its own source of tractive power rather than requiring an external means of propulsion.

In the middle of the 18th century, Benjamin Franklin's experiments showed that electrical phenomena of the atmosphere were not fundamentally different from those produced in the laboratory. By 1749, Franklin observed lightning to possess almost all the properties observable in electrical machines.

In July 1750, Franklin hypothesized that electricity could be taken from clouds via a tall metal aerial with a sharp point. Before Franklin could carry out his experiment, in 1752 Thomas-Francois Dalibard erected a 40-foot (12 m) iron rod at Marly-la-Ville, near Paris, drawing sparks from a passing cloud. With ground-insulated aerials, an experimenter could bring a grounded lead with an insulated wax handle close to the aerial, and observe a spark discharge from the aerial to the grounding wire. In May 1752, Dalibard affirmed that Franklin's theory was correct.

### Piezoelectric Motor

A piezoelectric motor or piezo motor is a type of electric motor based upon the change in shape of a piezoelectric material when an electric field is applied. Piezoelectric motors make use of the converse piezoelectric effect whereby the material produces acoustic or ultrasonic vibrations in order to produce a linear or rotary motion. In one mechanism, the elongation in a single plane is used to make a series stretches and position holds, similar to the way a caterpillar moves. A transducer is a device that converts one form of energy to another. Energy types include (but are not limited to) electrical, mechanical, electromagnetic (including light), chemical, acoustic or thermal energy. While the term transducer commonly implies the use of a sensor/detector, any device which converts energy can be considered a transducer. Transducers are widely used in measuring instruments. Piezoelectric materials can also be used to harvest low levels of mechanical energy into electrical energy suitable for powering wireless sensors, low power microprocessors or charging batteries. Rotary Uses include rotating machines such as fans, turbines, drills, the wheels on electric cars, locomotives and conveyor belts. Also, in many vibrating or oscillating machines, an electric motor spins an unbalanced mass, causing the motor (and its mounting structure) to vibrate.

### Atmospheric Electricity

There is always free electricity in the air and in the clouds, which acts by induction on the earth and electromagnetic devices. Experiments have shown that there is always free electricity in the atmosphere, which is sometimes negative and sometimes positive, but most generally positive, and the intensity of this free electricity is greater in the middle of the day than at morning or night and is greater in winter than in summer. In fine weather, the potential increases with altitude at about 30 volts per foot (100 V/m).

### Atmospheric Layers

The electrical conductivity of the atmosphere increases exponentially with altitude. The amplitudes of the electric and magnetic components depend on season, latitude, and height above the sea level. The greater the altitude the more atmospheric electricity abounds. The exosphere is the uppermost layer of the atmosphere and is estimated to be 500 km to 1000 km above the Earth's surface, and its upper boundary at about 10,000 km. The thermosphere (upper atmosphere) is the layer of the Earth's atmosphere directly above the mesosphere and directly below the exosphere. Within this layer, ultraviolet radiation causes ionization. Theories that have been proposed to explain the phenomenon of the polar aurora, but it has been demonstrated by experiments that it is due to currents of positive electricity passing from the higher regions of the atmosphere to the earth.

The mesosphere (middle atmosphere) is the layer of the Earth's atmosphere that is directly above the stratosphere and directly below the thermosphere. The mesosphere is located about 50-80/85 km above Earth's surface. The stratosphere (middle atmosphere) is a layer of Earth's atmosphere that is stratified in temperature and is situated between about 10 km and 50 km altitude above the surface at moderate latitudes, while at the poles it starts at about 8 km altitude. The stratosphere sits directly above the troposphere and directly below the mesosphere. The troposphere (lower atmosphere) is the densest layer of the atmosphere.

The planetary boundary layer (PBL), also known as the atmospheric boundary layer (ABL), is the lowest part of the atmosphere and its behavior is directly influenced by its contact with the planetary surface. It is also known as the “exchange layer”. (see also: p-n junction.)

There is a potential gradient at ground level (“Atmosphere ground layer”) and this vertical field corresponds to the negative charge in and near the Earth's surface. The negative potential gradient falls rapidly as altitude increases from the ground. Most of this potential gradient is in the first few kilometers. The positive potential gradient rises rapidly as altitude increases from the ground. Volta, over two centuries before the 21st century, discovered with some degree of exactitude that the proportions of the ordinates of the curve or gradient of electric potential increased as the distance from the earth increases, and, more recently, Engel has provided data to calculate the increase (Image to the right).

### Drum-Type Generator

A drum-type homopolar generator has a magnetic field (B) that radiates radially from the center of the drum and induces voltage (V) down the length of the drum. A conducting drum spun from above in the field of a “loudspeaker” type of magnet that has one pole in the center of the drum and the other pole surrounding the drum could use conducting ball bearings at the top and bottom of the drum to pick up the generated current.

### Astrophysical Unipolar Inductors

Unipolar inductors occur in astrophysics where a conductor rotates through a magnetic field, for example, the movement of the highly conductive plasma in a cosmic body's ionosphere through its magnetic field. In their book, Cosmical Electrodynamics, Hannes Alfvén and Carl-Gunne Fälthammar write:

“Since cosmical clouds of ionized gas are generally magnetized, their motion produces induced electric fields [ . . . ] For example the motion of the magnetized interplanetary plasma produces electric fields that are essential for the production of aurora and magnetic storms” [ . . . ]

“ . . . the rotation of a conductor in a magnetic field produces an electric field in the system at rest.

This phenomenon is well known from laboratory experiments and is usually called ‘homopolar’ or ‘unipolar’ induction.

### The Faraday Disc

The homopolar generator was developed first by Michael Faraday during his experiments in 1831. It is frequently called the Faraday disc in his honor. It was the beginning of modern dynamos—that is, electrical generators which operate using a magnetic field. It was very inefficient and was not used as a practical power source, but it showed the possibility of generating electric power using magnetism, and led the way for commutated direct current dynamos and then alternating current alternators.

### Boeing 737-800

The Boeing Fuel Cell Demonstrator Airplane has a Proton Exchange Membrane (PEM) fuel cell/lithium-ion battery hybrid system to power an electric motor, which is coupled to a conventional propeller. The fuel cell provides all power for the cruise phase of flight. During takeoff and climb, the flight segment that requires the most power, the system draws on lightweight lithium-ion batteries.

The demonstrator aircraft is a Dimona motor glider, built by Diamond Aircraft Industries of Austria, which also carried out structural modifications to the aircraft. With a wing span of 16.3 meters (53.5 feet), the airplane will be able to cruise at approximately 100 kilometers per hour (62 miles per hour) on power from the fuel cell.

Nikola Tesla explored the wireless transmission of energy through his work with radio and microwaves and his creation of the Tesla coil and the magnifying transmitter. In 1898, Tesla demonstrated his radio-controlled boat, which he was able to control remotely. In the 1930s, Tesla claimed to have invented a particle beam weapon, or, as some called it, a “peace ray.” The device was, in theory, capable of generating an intense, targeted beam of energy and sending it across great distances to demolish warplanes, foreign armies, or anything else you'd rather didn't exist.

“Roy J. Meyers, British Patent Number 1098”

This invention relates to improvements in apparatus for the production of electrical currents, and the primary object in view is the production of a commercially serviceable electrical current without the employment of mechanical or chemical action. To this end the invention comprises means for producing what I believe to be dynamic electricity from the earth and its ambient elements.

Edward Leedskalnin: Magnetic Current—

The Perpetual Motion Holder is primarily a teaching device but it has many functions including an electromagnet, this is easy enough to see; it is a generator—spin a magnet between the coils it will generate electricity; it functions as a transformer; it demonstrates how permanent magnets are made, and is a holder of perpetual motion.

### Strategic Defense Initiative

The Strategic Defense Initiative (SDI) was proposed to use ground and space-based systems to protect the United States from attack by strategic nuclear ballistic missiles.

### Description of the Related Art

The present invention relates to a ball bearing assembly structure, an electromagnetic clutch having the ball bearing assembly structure, and a gas compressor equipped with the electromagnetic clutch.

When operating the gas compressor, the electromagnet of the electromagnetic clutch is energized to attract or adsorb the follower armature plate to an end surface of the prime-mover pulley and join the prime-mover pulley and the rotor shaft, thereby rotating the rotor shaft.

The ball bearing of the electromagnetic clutch conventionally has used one having an even number of balls per row. Generally, the ball bearing causes vibration and noise due to rotation. In the case of the ball bearing rotating while undergoing a radial load due to a tension of the belt, vibration and noise considerably occur. Particularly when other vibration and noise levels are lowered during engine idling, the vibration and noise of the ball bearing transmitted to the vehicular compartment is not negligible.

The inventor has conducted various experiments and discovered that the one factor of high vibration and noise level is an even number of balls of the ball bearing. In the ball bearing having an even number of balls per one row, the balls are in a facing relation to have linear-symmetry arrangement between the inner race and the outer race. The deformation and vibration at a regular particular frequency is caused in the inner and outer races. It is to be considered that the vibration as a source also increases noise.

The present invention relates generally and in various embodiments to piezoelectric mechanical systems. More specifically, the present invention relates generally and in various embodiments to atmospheric oscillation transducer apparatuses, systems, and methods.

Although various implementations of the present invention, among many, may be described herein with reference to the specific illustrative embodiments related to particular applications, those skilled in the art will understand that the invention is not in any way intended to be limited to such embodiments and/or applications. Those having ordinary skill in the art and reference to the description of the embodiments herein will recognize additional modifications, applications, and other embodiments falling within the scope of the claimed invention and additional fields in which the present invention may be practiced.

Digital Radio (also known as Satellite Radio or Satellite Digital Audio Radio Service (SDARS)) is a subscriber-based digital radio service that is broadcast via satellites. Digital radio service provides compact-disc (CD) quality programming that may be digitally transmitted via one or more satellites and/or space stations to one or more Earth-based (terrestrial) digital radio stations, receivers, and/or repeaters. In satellite-based direct-broadcast radio services, digitally-encoded audio program material may be broadcast to terrestrial fixed or mobile digital radio receivers. Fixed receivers may include, for example, stand alone digital radio receivers or digital radio receivers connected via computer networks, including for example, the Internet. Mobile receivers may include, for example, digital radio receivers located in automobiles, aircrafts, watercrafts, and the like.

Satellite-based digital audio radio services such as SDARS, for example, may be broadcast to one or more digital radio receivers either directly from an orbiting satellite, or indirectly from one or more repeater stations. Such repeater stations may be useful where the digital radio receiver is located in a shielded location or where there is no direct line of sight between the radio and the satellite. In other digital audio radio services systems, the audio programs also may be transmitted in digital form by one or more space stations directly to fixed, mobile, and/or portable radio stations. Such systems may comprise, for example, orbiting satellites, complementary repeating terrestrial transmitters, telemetry, tracking, and control facilities.

Combinations of mechanical devices U.S. Pat. Nos. 4,019,073, 6,615,968 and atmospheric system interaction are disclosed in U.S. Pat. Nos. 1,119,732, 787,412, 6,902,513 to Nikola Tesla; 28,793 to Charles Vion; and U.S. Pat. No. 1,540,998 to Herman Plauson. Lastly, U.S. Pat. No. 8,102,078 and US2008/0009240. Agnoff discloses an Oscillating watch winder in U.S. Pat. No. 6,543,929, Jennings further discloses an oscillating smart device in application No. 13,572,679.

As illustrated by a large body of prior art, including the above-noted patents, and a large number of commercial devices, efforts are continuously being made in an attempt to improve helmets, headsets and their methods of fabrication. Nothing in the prior art, however, suggests the present inventive combination of materials and method steps as herein described and claimed. The present invention achieves its purposes, objects and advantages over the prior art through a new, useful and unobvious combination of components and method steps which improve safety, comfort and noise abatement performance.

Therefore, it is an object of this invention to provide Effectively, the provision of energy such that it meets the needs of the present without compromising the ability of future generations to meet their own needs . . . . Sustainable Energy has two key components: renewable energy and energy efficiency.

It is still a further objection of this invention to promote Dynamic harmony between equitable availability of energy-intensive goods and services to all people and the preservation of the earth for future generations.” And, “the solution will lie in finding sustainable energy sources and more efficient means of converting and utilizing energy.

It is a further object of the present invention to produce Green Power Energy: is energy that can be extracted, generated, and/or consumed without any significant negative impact to the environment, green power; as electricity produced from solar, wind, geothermal, biogas, biomass, and low-impact small hydroelectric sources.

Thus, there is a need for a clean energy system that uses atmospheric electricity.

### Prior Art

Quartz crystals have been in regular use for many years to give an accurate frequency for all radio transmitters, radio receivers and computers. Their accuracy comes from an amazing set of coincidences: Quartz—which is silicon dioxide like most sand—is unaffected by most solvents and remains crystalline to hundreds of degrees Fahrenheit. The property that makes it an electronic miracle is the fact that, when compressed or bent, it generates a charge or voltage on its surface. This is a fairly common phenomenon called the Piezoelectric effect. In the same way, if a voltage is applied, quartz will bend or change its shape very slightly.

If a bell were shaped by grinding a single crystal of quartz, it would ring for minutes after being tapped. Almost no energy is lost in the material. A quartz bell—if shaped in the right direction to the crystalline axis—will have an oscillating voltage on its surface, and the rate of oscillation is unaffected by temperature. If the surface voltage on the crystal is picked off with plated electrodes and amplified by a transistor or integrated circuit, it can be re-applied to the bell to keep it ringing.

The electronics of the watch initially amplifies noise at the crystal frequency. This builds or regenerates into oscillation—it starts the crystal ringing. The output of the watch crystal oscillator is then converted to pulses suitable for the digital circuits.

### Polymers

Polyvinylidene fluoride (PVDF): PVDF exhibits piezoelectricity several times greater than quartz. Unlike ceramics, where the crystal structure of the material creates the piezoelectric effect, in polymers the intertwined long-chain molecules attract and repel each other when an electric field is applied.

### Near Space

Solar particles become trapped within the Earth's magnetic field and form radiation belts. The Van Allen radiation belt is a torus of energetic charged particles (i.e. a plasma) around Earth, trapped by Earth's magnetic field.

At elevations above the clouds, atmospheric electricity forms a continuous and distinct element (called the electrosphere) in which the Earth is surrounded. The electrosphere layer (from tens of kilometers above the surface of the earth to the ionosphere) has a high electrical conductivity and is essentially at a constant electric potential. The ionosphere is the inner edge of the magnetosphere and is the part of the atmosphere that is ionized by solar radiation. (Photoionisation is a physical process in which a photon is incident on an atom, ion or molecule, resulting in the ejection of one or more electrons.)

### Advantages/Disadvantages

Energy in electronic elements: Electric potential energy, or electrostatic potential energy, is a potential energy (measured in joules) that results from conservative Coulomb forces and is associated with the configuration of a particular set of point charges within a defined system. The term “electric potential energy” is used to describe the potential energy in systems with time-variant electric fields, while the term “electrostatic potential energy” is used to describe the potential energy in systems with time-invariant electric fields.

Capacitance is the ability of a body to store an electrical charge. Any body or structure that is capable of being charged, either with static electricity or by an electric current, exhibits capacitance. A common form of energy storage device is a parallel-plate capacitor. In a parallel plate capacitor, capacitance is directly proportional to the surface area of the conductor plates and inversely proportional to the separation distance between the plates. If the charges on the plates are +q and −q, and V gives the voltage between the plates, then the capacitance C is given by

C=q/V.

The capacitance is a function only of the physical dimensions (geometry) of the conductors and the permittivity of the dielectric. It is independent of the potential difference between the conductors and the total charge on them.

Piezoelectricity is the combined effect of the electrical behavior of the material:

D=∈E

where D is the electric charge density displacement (electric displacement), ∈ is permittivity and E is electric field strength, and

Hooke's Law: S=sT

where S is strain, s is compliance and T is stress.

Polyvinylidene fluoride, or polyvinylidene difluoride (PVDF) is a highly non-reactive and pure thermoplastic fluoropolymer produced by the polymerization of vinylidene difluoride. PVDF is a specialty plastic material in the fluoropolymer family; it is used generally in applications requiring the highest purity, strength, and resistance to solvents, acids, bases and heat and low smoke generation during a fire event. Compared to other fluoropolymers, it has an easier melt process because of its relatively low melting point of around 177° C.

It has a low density (1.78) and low cost compared to the other fluoropolymers. It is available as piping products, sheet, tubing, films, plate and an insulator for premium wire. It can be injected, molded or welded and is commonly used in the chemical, semiconductor, medical and defense industries, as well as in lithium ion batteries. It is also available as a crosslinked closed cell foam, used increasingly in aviation and aerospace. PVDF has a glass transition temperature (Tg) of about −35° C. and is typically 50-60% crystalline. To give the material its piezoelectric properties, it is mechanically stretched to orient the molecular chains and then poled under tension. PVDF exists in several forms: alpha (TGTG′), beta (TTTT), and gamma (TTTGTTTG′) phases, depending on the chain conformations as trans (T) or gauche (G) linkages. When poled, PVDF is a ferroelectric polymer, exhibiting efficient piezoelectric and pyroelectric properties. These characteristics make it useful in sensor and battery applications. Thin films of PVDF are used in some newer thermal camera sensors.

Copolymers: Copolymers of PVDF are also used in piezoelectric and electrostrictive applications. One of the most commonly-used copolymers is P(VDF-trifluoroethylene), usually available in ratios of about 50:50 wt % and 65:35 wt % (equivalent to about 56:44 mol % and 70:30 mol %). Another one is P(VDF-tetrafluoroethylene). They improve the piezoelectric response by improving the crystallinity of the material.

While the copolymers' unit structures are less polar than that of pure PVDF, the copolymers typically have a much higher crystallinity. This results in a larger piezoelectric response: d33 values for P(VDF-TrFE) have been recorded to be as high as −38 pC/N versus −33 pC/N in pure PVDF.

Applications:

The piezoelectric properties of PVDF are used to advantage to manufacture tactile sensor arrays, inexpensive strain gauges and lightweight audio transducers. Piezoelectric panels made of PVDF are used on the Venetia Burney Student Dust Counter, a scientific instrument of the New Horizons space probe that measures dust density in the outer solar system. PVDF is the standard binder material used in the production of composite electrodes for lithium ion batteries. 1-2% weight solution of PVDF dissolved in N-Methyl-2-pyrrolidone (NMP) is mixed with an active lithium storage material such as graphite, silicon, tin, LiCoO2, LiMn2O4, or LiFePO4 and a conductive additive such as carbon black or carbon nanofibers. This slurry is cast onto a metallic current collector and the NMP is evaporated to form a composite or paste electrode. PVDF is used because it is chemically inert over the potential range used and does not react with the electrolyte or lithium. Piezoelectric elements can be used in laser mirror alignment, where their ability to move a large mass (the mirror mount) over microscopic distances is exploited to electronically align some laser mirrors. By precisely controlling the distance between mirrors, the laser electronics can accurately maintain optical conditions inside the laser cavity to optimize the beam output. Piezoelectric sensors especially are used with high frequency sound in ultrasonic transducers for medical imaging and also industrial nondestructive testing (NDT).

For many sensing techniques, the sensor can act as both a sensor and an actuator—often the term transducer is preferred when the device acts in this dual capacity, but most piezo devices have this property of reversibility whether it is used or not. Ultrasonic transducers, for example, can inject ultrasound waves into the body, receive the returned wave, and convert it to an electrical signal (a voltage). Most medical ultrasound transducers are piezoelectric.

Advantageously,

Sustainable energy is the sustainable provision of energy that meets the needs of the present without compromising the ability of future generations to meet their needs. Technologies that promote sustainable energy include renewable energy sources, such as hydroelectricity, solar energy, wind energy, wave power, geothermal energy, and tidal power, and also technologies designed to improve energy efficiency.

This sequence of oscillations causes the rotor within the watch to spin rapidly thereby winding the watch in a manner closely simulating the spinning of the rotor that occurs during normal winding of the watch when the watch is worn by a user. Due to the forces that are exerted, the rotor spins around the watch shaft during the oscillations, as opposed to the partial rotation observed in prior art mechanisms. Therefore, the time required to wind the watch, and the energy required, is substantially reduced. Moreover, since the rotor is spinning about the shaft, as opposed to merely being held in a downward position while the watch is rotated, winding more closely approximating the design mechanism is achieved, thereby putting less wear on the watch.

This invention relates to satellite communications systems using multiple spot beams from a geosynchronous earth orbit satellite to provide selective coverage of the continental United States and, more particularly, relates to a system having a satellite receiving hub in every spot beam that allows for asynchronous communications between each hub and the satellite for maximizing frequency re-use.

These purposes, objects and advantages should be construed as merely illustrative of some of the more prominent features and applications of the present invention. Many other beneficial results can be obtained by applying the disclosed invention in a different manner or by modifying the invention within the scope of the disclosure. Accordingly, other purposes, objects and advantages as well as a fuller understanding of the invention may be had by referring to the summary herein mentioned and detailed description describing the preferred embodiments of the invention, in addition to the scope of the invention, as defined by the claims, taken in conjunction with the accompanying drawings.

### SUMMARY OF THE INVENTION

In one general respect, an embodiment of the present invention is directed to a system. The system includes a Power Frequency broadcast station, a receiver, and a network. The Power Frequency broadcast station includes a transmitter and a server. The receiver is in communication with the Power Frequency broadcast transmitter and also includes a user interface for receiving user input commands comprising a request for information from the Power Frequency broadcast station.

The receiver is configured to establish a two-way communication path between the receiver and the Power Frequency broadcast transmitter. The network is in communication with the server and the receiver for exchanging information therebetween. The request for information is provided to the server via the network and the server is configured to receive the request and transmit a response message to the receiver in accordance with the request.

### Continuously Outboard Recharged Electric Vehicle (COREY)

Given suitable infrastructure, permissions and vehicles, BEVs (battery electric vehicles) can be recharged while the user drives. The BEV establishes contact with an electrified rail, plate or overhead wires on the highway via an attached conducting wheel or other similar mechanism (see Conduit current collection). The BEV's batteries are recharged by this process—on the highway—and can then be used normally on other roads until the battery is discharged. Some of battery-electric locomotives used for maintenance trains on the London Underground are capable of this mode of operation. Power is picked up from the electrified rails where possible, switching to battery power where the electricity supply is disconnected.

The present invention is directed to overcome the disadvantages of the prior art. The invention is a mechanism which taps into the naturally occurring static electricity in the atmosphere. Whereas heretofore, the attempt to garner electricity from the atmosphere has focused exclusively on capturing lightning, the present invention syphons off the static electricity which is generated from any agitated air and voids lightning.

Lightning is only the final discharge of the static electricity, whether that lightning is intra-cloud lightning, cloud-to-ground lightning, or inter-cloud lightning. Other types of final discharges are known as heat lightning, summer lightning, sheet lightning, ribbon lightning, silent lightning, ball lightning, bead lightning, elves, jets, and sprites. Well before these discharges are observed, as the atmosphere becomes agitated by wind or thermal, static electricity is being generated. The present invention recognizes that this static electricity is being formed and creates a mechanism to capture it.

In the preferred embodiment, a sensor array is used to monitor the activities both at the base unit (such as electrical flow within the conductor) and in the surrounding locale. A sensor monitoring the electrical flow (i.e. voltage and/or current) within the conductor is used to monitor the electrical activity within the conductor.

In the preferred embodiment, a lightning sensor monitors for lightning activity within the locale. As noted earlier, the electrical characteristic of lightning is so extreme that ideally this discharge is avoided as it might damage the mechanism of this invention. The sensor array is utilized by a controller, such as microprocessor, programmed to operate the mechanism as outlined herein.

The controller operates the winch motor to extend or withdraw the conductive line and by extension the altitude of the balloon. The controller is programmed to operate the winch by monitoring the electrical characteristics of the conductor and adjusting the balloon's altitude to maintain these characteristics within the conductor within a preset range.

This preset range is established either in the base programming of the controller or is established by an operator of the system. As example, by controlling the amount of current being withdrawn from the atmosphere, the mechanism operates within a safe range and also provides a relatively stable current flow from which a variety of activities can take place (such as DC-AC conversion).

The controller also utilizes the lightning sensor to protect the mechanism from a lightning strike. Should lightning be detected within a pre-determined range (as established by the software or defined by an operator), then the balloon is pulled down to minimize the risk of damage from a lightning strike.

Another aspect of the invention relates to the electrical system which accepts the fluctuating atmospheric charge and changes it into an acceptable configuration for either the desired load or for the existing power grid.

Power grids in the United States operate with a frequency of 60 hertz in an alternating current arrangement. While this basic configuration seems to be universally accepted, the voltage within the grid varies dramatically, such as 15 kv, 34 kv, 69 kv, and even 112 kv.

Each atmospheric generator is placed proximate to or within easy access to a specific grid; this establishes the required electrical output configuration (i.e. that which is accepted by the power grid). As example, one of the atmospheric electrical collector units as described above collects the atmospheric electrical power as direct current and then supplies the appropriate power grid a specific flow (as example, AC, 60 hertz, at 69 kv).

The difficulty lies the fact that the DC current being garnered from the atmosphere varies depending on the actual agitation being generated in the atmosphere. This means that the source of DC current is fluctuating.

The present invention uses a monitoring system which checks the input DC voltage. Depending on the actual voltage being received, the appropriate converter is connected to the input DC voltage so that the desired output is obtained.

As example, suppose the DC input voltage is 1500 volts, the monitoring system, sensing this input, closes the switch connecting the DC voltage to a converter which accepts DC voltage in the range of 1000-2000 volts which then delivers an AC, 60 hertz 69 kv signal to the power grid. If the DC input voltage increases to 2100 volts, then the monitoring system opens the switch to the first converter (1000-2000 volts) and closes the switch to a second converter (such as 2000-4000 volts) to deliver the desired output of AC (60 hertz, 69 kv) for the power grid.

In this manner, regardless of the fluctuating input DC voltage, the electrical grid is supplied with a fully configured electrical input conforming to the needs of that specific electrical grid.

Another aspect of the present invention is the use of a tower or permanent structure instead of an aircraft. In this embodiment, the building or tower is electrically isolated from the ground and a rod (similar to a lightning rod) is extended into the atmosphere. The rod collects the atmospheric charge which is conveyed via an electrical conduit (ideally insulated) where the collected DC charge is reconfigured to meets the need of the locale.

In this context, for one embodiment of the invention, a tower is placed onto the top of a building. The tower is electrically isolated from the building using such mechanisms well known to those of ordinary skill in the art such as rubber mats. A rod ideally extends from the top of the tower to facilitate the collection of the DC electrical energy.

Piezoelectricity is a material property that is manifested when voltage is produced by applying mechanical forces, and vice versa, the effect has been described as direct and converse. Piezoelectricity has been described as coupling between a quasi-static electric field and dynamic mechanical motion.

A piezoelectricity converter mechanism such as described above, is connected to the tower to flow the DC electricity to a converter which modifies the DC current for the specific application. In one application, the DC current is converted to the electrical needs of the building, thereby providing at least some of the electrical requirements of the building itself.

As noted earlier, the dynamic converter system of the present invention allows a power generator to address a variable voltage in an efficient manner. This makes the dynamic converter system ideal for a variety of alternative energy sources such as the above described atmospheric electrical generator and other alternative energy sources such as wind and wave powered systems. In these systems, the energy being generated must be converted to a proper electrical configuration for a identified load. This may be a particular motor or connection to the power grid which act as a load to the power generating mechanism.

For these energy generating systems, the converter assembly of this invention utilizes multiple converters. Each converter is configured to accept a unique range of voltages and from these voltages, create the desired electrical configuration. By using multiple converters, a full range is available, from a minimum voltage input to a maximum voltage input.

The present invention can include systems and methods for integrating sensors for tracking atmospheric transducer system performance metrics into media devices and accessories therefor, thereby reducing or eliminating the need for additional independent monitoring devices. In one embodiment of the present invention.

It also is known to provide such transducers with connectors to allow their rechargeable batteries to be charged. In some cases, the connector is a Universal Serial Bus (USB) connector, allowing the transducer to be charged by plugging it into the USB port of a computer, grid circuit or other device.

These and other objects and advantages of the invention will appear more clearly from the following description in which the preferred embodiment of the invention has been set forth in conjunction with the drawings.

### BRIEF DESCRIPTION OF THE DRAWINGS

FIG. 1 Prior Art depicts perspective view of Electric currents created in sunward ionosphere;

FIG. 2 is a box flow chart of the propulsion cycle systems present invention;

FIG. 3 is an top view of the piezoelectric disk cylinder orb of the present invention;

FIG. 4 is a longitudinal sectional view showing an embodiment of this invention;

FIG. 5 is a top view of the (ATS) slip rotor piezoelectric chamber of the present invention;

FIG. 6 is an alternate top view of the piezoelectric cylinder orb of the present invention;

FIG. 7-10 elevation views of spine piezo stacks embodiments of the present invention;

FIG. 11 illustrates one embodiment of a power service (ATS) system architecture;

FIG. 12 is a block diagram of the ATS charge schematics systems of the present invention;

FIG. 13 is a block diagram of an ATS charge and recycle schematics of the present invention;

FIG. 14 is a view of the piezoelectric ball race cylinder of the present invention;

FIG. 15 is a view of the piezoelectric housing and gear of the present invention;

FIG. 16 is a view of a multiple piezoelectric ball race cylinder of the present invention;

FIG. 17 is another embodiment of the piezoelectric stack ball of the present invention;

FIGS. 18 & 19 are antenna rod transmit device embodiments of the (ATS) present invention;

FIG. 20 illustrates substation embodiment of the power service (ATS) system architecture;

FIG. 21 illustrates a home embodiment of the power service (ATS) system architecture;

FIG. 22 illustrates a window embodiment of the power service (ATS) system architecture;

FIG. 23 is (ATS) shock device in accordance with an embodiment of the present invention;

FIG. 24 is (ATS) shock device in accordance with an embodiment of the present invention;

FIG. 25 is (ATS) motorcycle device embodiment of the present invention;

FIG. 26 is (ATS) axle device in accordance with an embodiment of the present invention;

FIG. 27 is (ATS) train device in accordance with an embodiment of the present invention;

FIG. 28 is (ATS) plane device in accordance with an embodiment of the present invention;

FIG. 29 is (ATS) boat device in accordance with an embodiment of the present invention;

FIG. 30 is (ATS) solar device in accordance with an embodiment of the present invention;

FIG. 31 a (ATS) turbine device in accordance with an embodiment of the present invention;

FIG. 32 is (ATS) auto body panel device embodiment of the present invention;

FIG. 33 is (ATS) motorcycle body fairing panel device in of the present invention; and

FIG. 34 is (ATS) cross section view of body embed panel device of the present invention.

### DETAILED DESCRIPTION

This sequence of oscillations causes the conductive rotor within piezoelectric molded housing device to spin rapidly thereby winding the mechanism in a manner closely simulating the spinning of the conductive rotor that occurs during normal electric activity when the device is activated. Due to the forces that are exerted, the conductive rotor spins around the piezoelectric cylinder device shaft during the oscillations, as opposed to the partial rotation observed in prior art mechanisms. Therefore, the time required to charge the Atmospheric Transduction System (ATS) device, and the energy required, is substantially reduced. Moreover, since the rotor is spinning about the shaft, as opposed to merely being held in a downward position while the ATS device is rotated, recharging more closely approximating the design mechanism is achieved, thereby putting less wear on the ATS chamber device Innovative Piezoelectric housing and ball bearing, coupler and book spine stacks. There relies the notion of negative ground electricity and positive aerial electricity which is in abundance. This invention substantiates land vehicles recycle recharge by reverse oscillation. Aerial vehicles recycle recharge by forward oscillation in accumulation of environmental positive and negative electricity. These aforementioned activities are integral or synchronous with frequency.

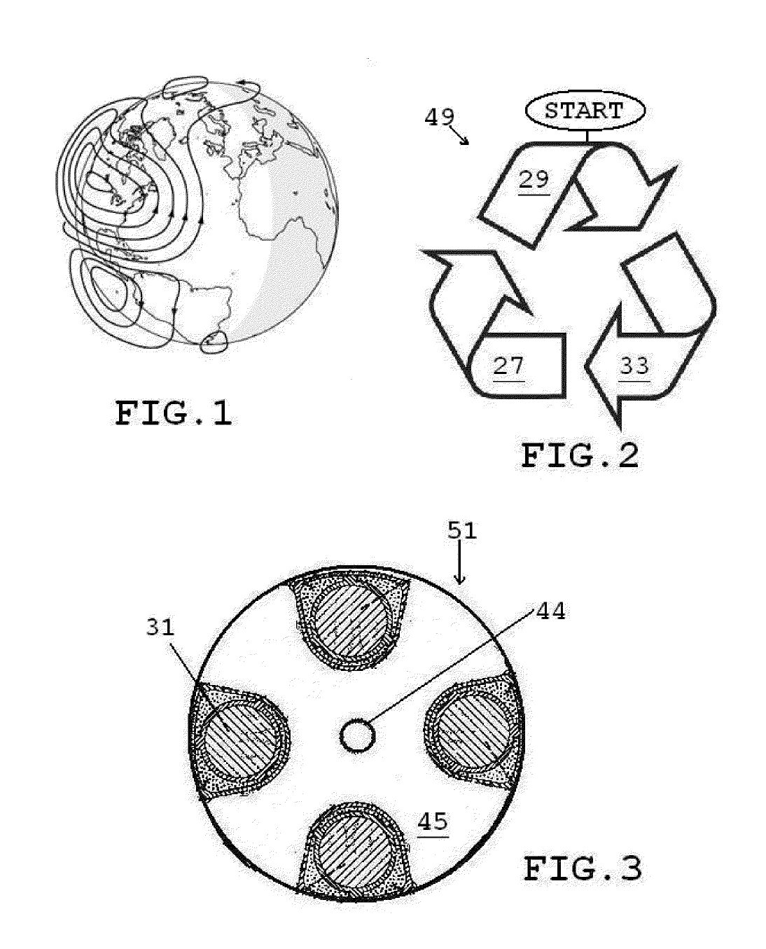

Prior Art FIG. 1

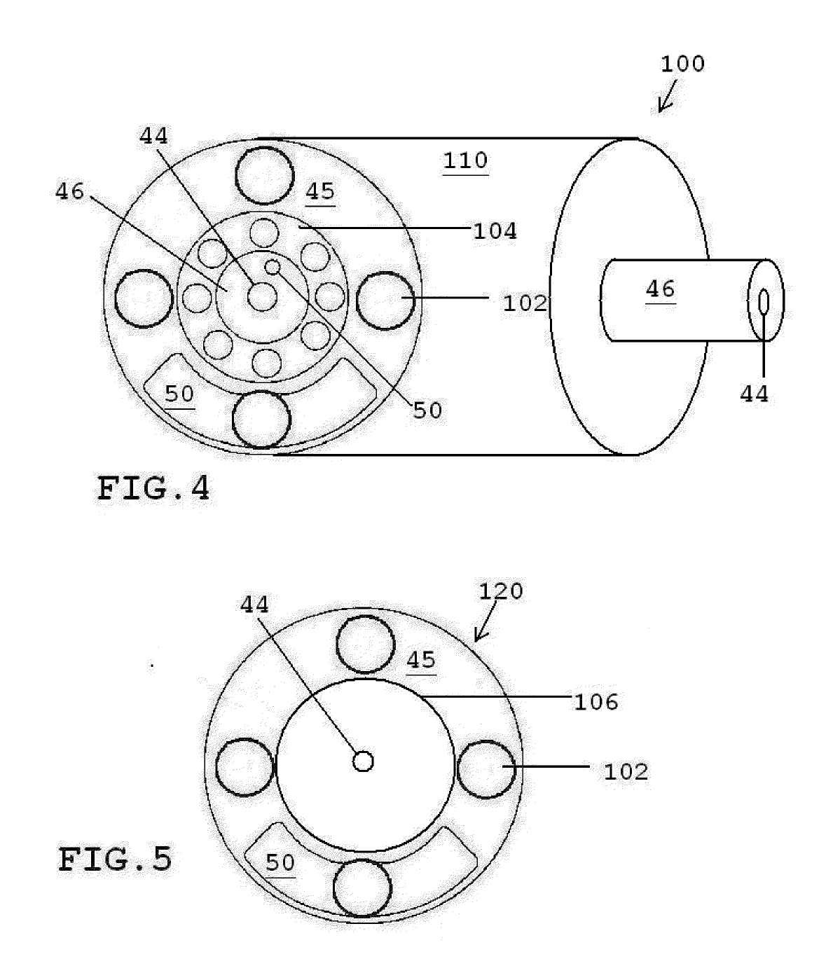

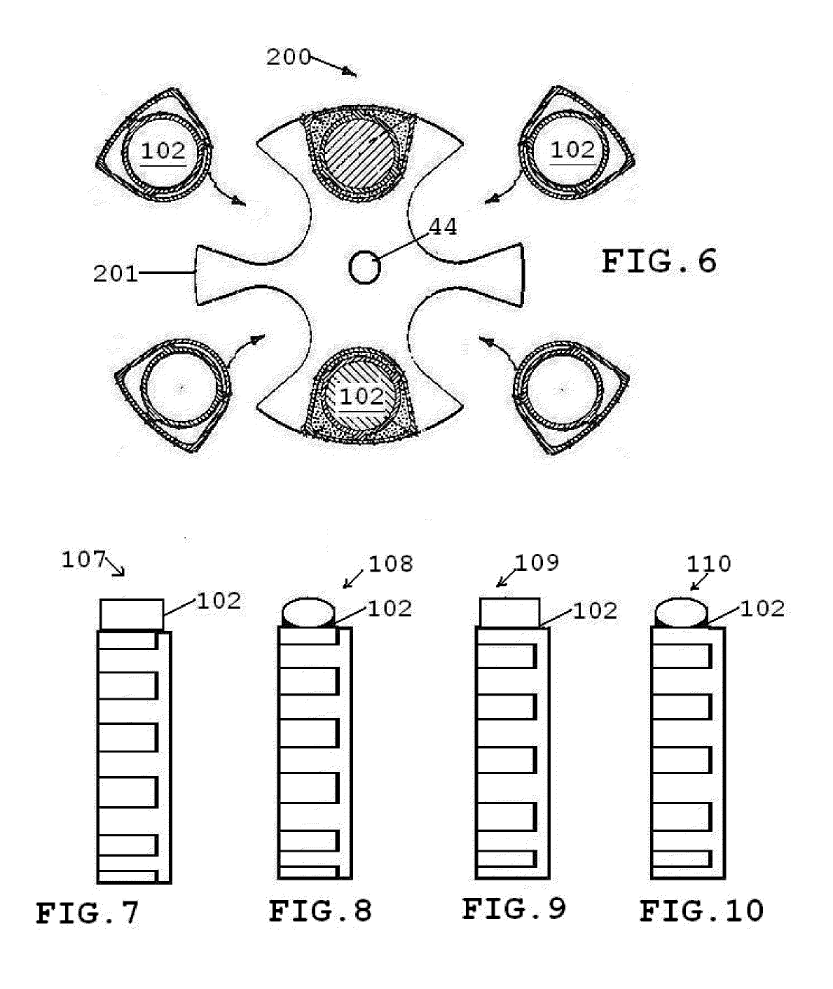

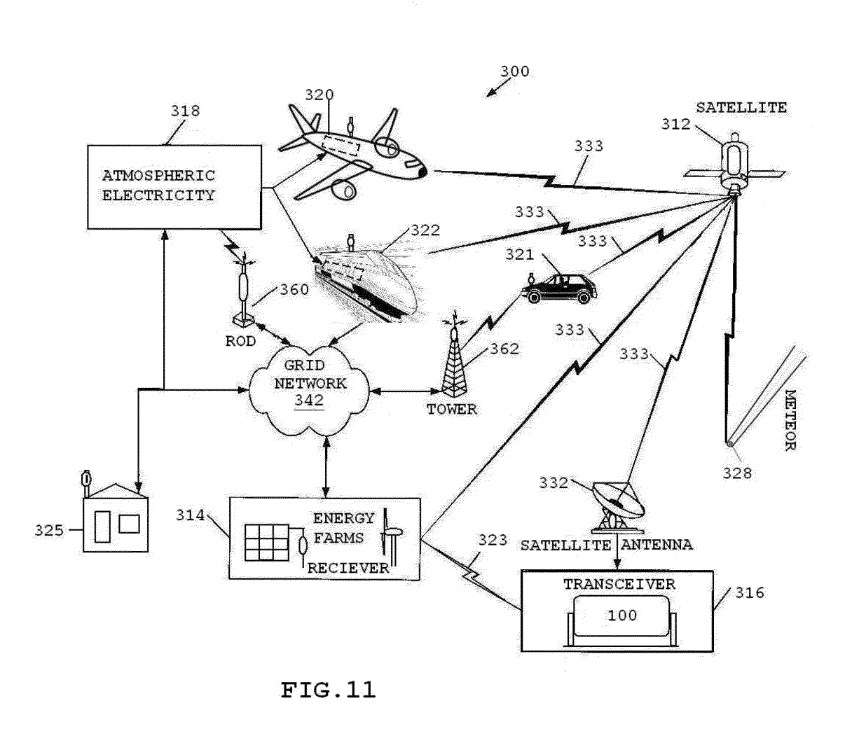

Electric currents created in sunward ionosphere. FIG. 2 is a recycle box flow chart 49 of a self propulsion unit consisting of a battery 27, engine 29 and piezoelectric transducer 33 unit. FIG. 3 is a multiple disk 31 load part 51 about a 360 degree cylinder 45 and shaft 44. FIG. 4 is a piezoelectric molded device 100 housing 110 containing a ball bearing race 104, disk stacks capacitor 102 and conductive rotor 46. FIG. 5 is a piezoelectric chamber 120 configuration including a counterweights 50, shaft 44, conductive slip rotor 106. FIG. 6 is an alternate part 200 chamber cylinder 201 embodiment containing piezoelectric spine disk stack capacitors 102. FIG. 7-10 are variations of spine 107,108,109,110 case piezoelectric stack capacitor 102 with plate and ball heads. FIG. 11 Various embodiments of the present invention, among others, will now be described with reference to the accompanying drawings. Accordingly, FIG. 11 illustrates an embodiment of a Atmospheric Transduction (ATS) System 300 architecture. The system 300 may include, for example, a satellite broadcast station 318 that transmits signals 333 containing frequency content from a geostationary satellite 312 by way of airplane antenna 326. In turn, the satellite 312 transmits line-of-sight (LOS) signals 333 to one or more ATS terrestrial frequency power receiver farms 314. The system 300 also may include one or more terrestrial repeaters 316 which receive and retransmit the satellite signals 333 as repeater signals 323 to facilitate reliable reception in geographic areas where LOS reception from the satellite 312 is obstructed by tall buildings, hills, tunnels, and other similar impediments to the signals 333. The ATS receivers 314 maybe designed to receive one or more signals 333 from the satellite 312 and/or from the terrestrial repeater transceiver 316. In operation, such ATS receivers 314 may receive both the satellite signals 333 and the repeater signals 323. The receivers 314 also may be located in mobile environments 320, 321, 322 which include, but are not limited to, land vehicles 321, 322, aircraft 320, watercraft 900, and handheld devices, among others. The receivers 314 also may be fixed in stationary units for residential use (e.g., home 325,750 entertainment, etc.) or commercial 314, 328,360 use (e.g., business 314, office 700, security 328, etc.). The power frequency broadcast station 318 also may be in communication with a grid network 342. Two-way communication between the ATS receivers 314 and the power frequency broadcast station 318 may occur via the network 342. Furthermore, information feedback from the power frequency broadcast station 318 may be transmitted to the ATS receiver 314 both by way of the network 342 as well as via the satellite 312. Information also may be transmitted to the power broadcast station 318 wirelessly via a wireless network 342,707 by way of transducer tower 360.

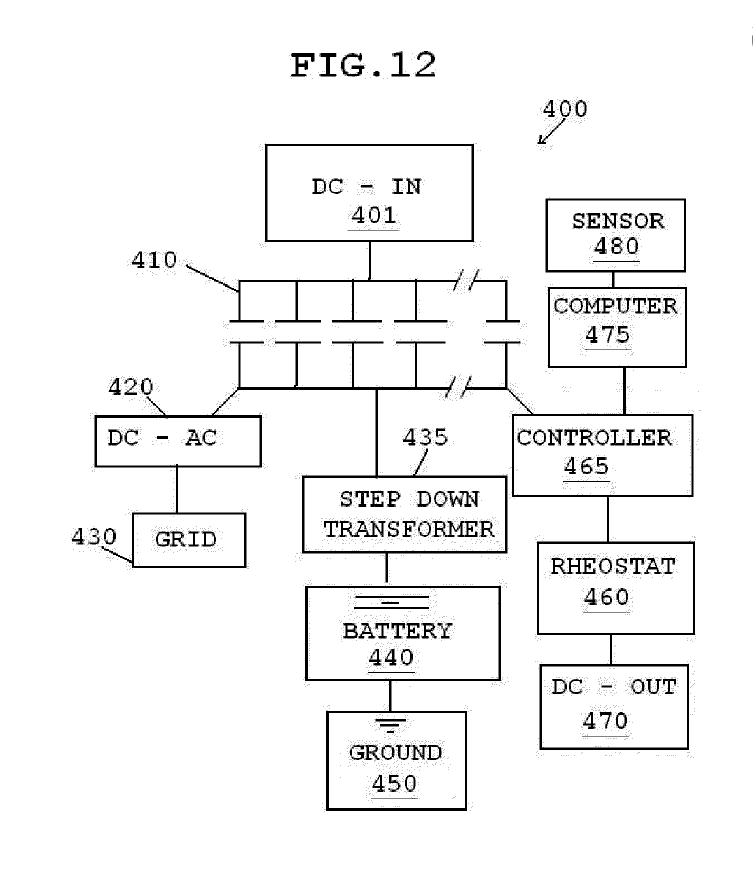

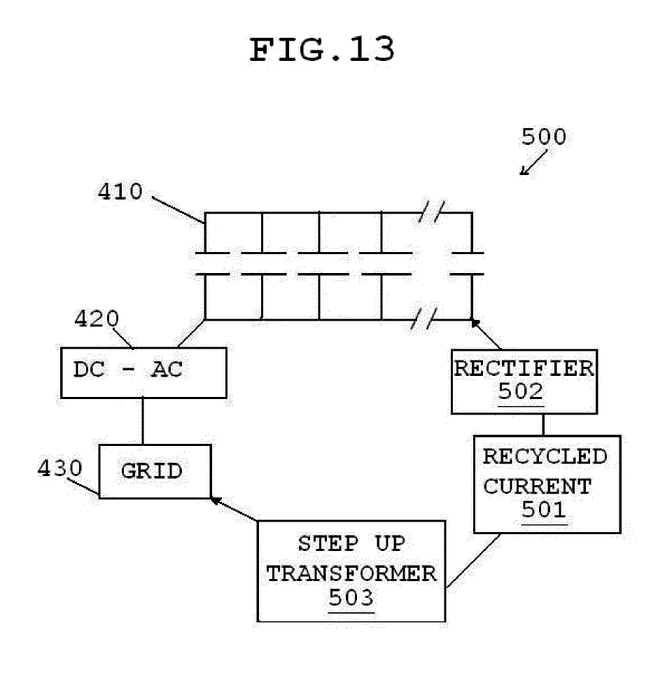

Further disclosed in FIG. 12 and FIG. 13 (in block diagrams 400, 500) are electrical schematics for handling the static charge from the atmosphere. By maintaining the voltage being collected in a prescribed range, an electrical conversion system is easily designed. While FIGS. 12, and 13 illustrate some electrical configurations, those of ordinary skill in the art readily recognize a variety of other configurations which will serve the same function.

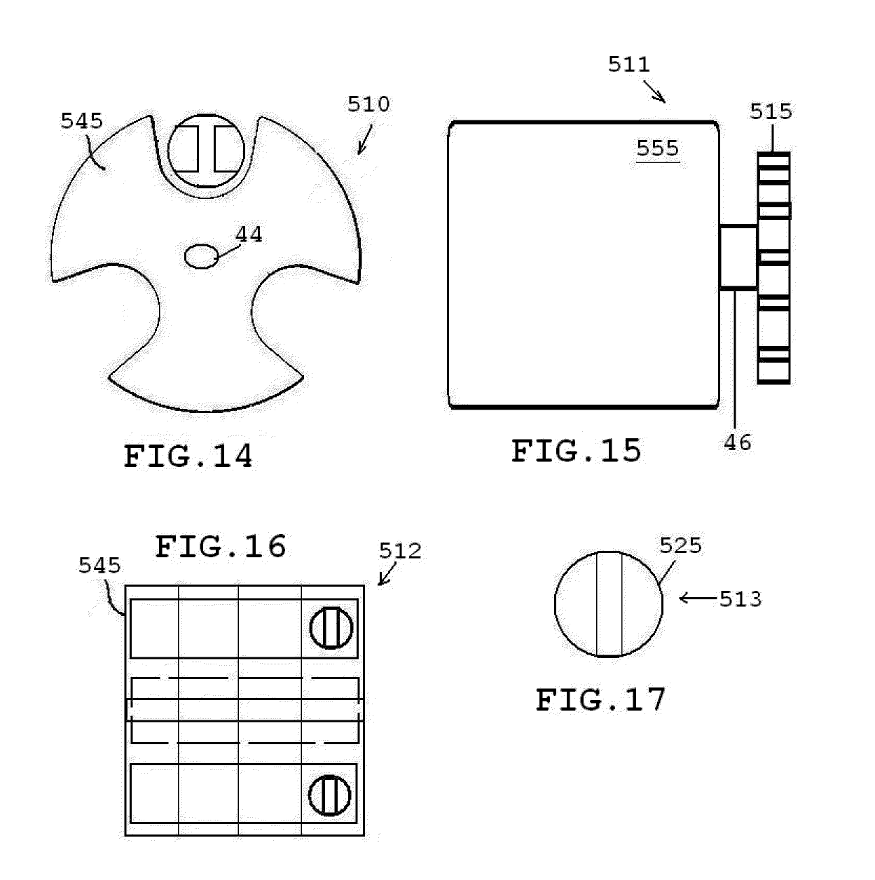

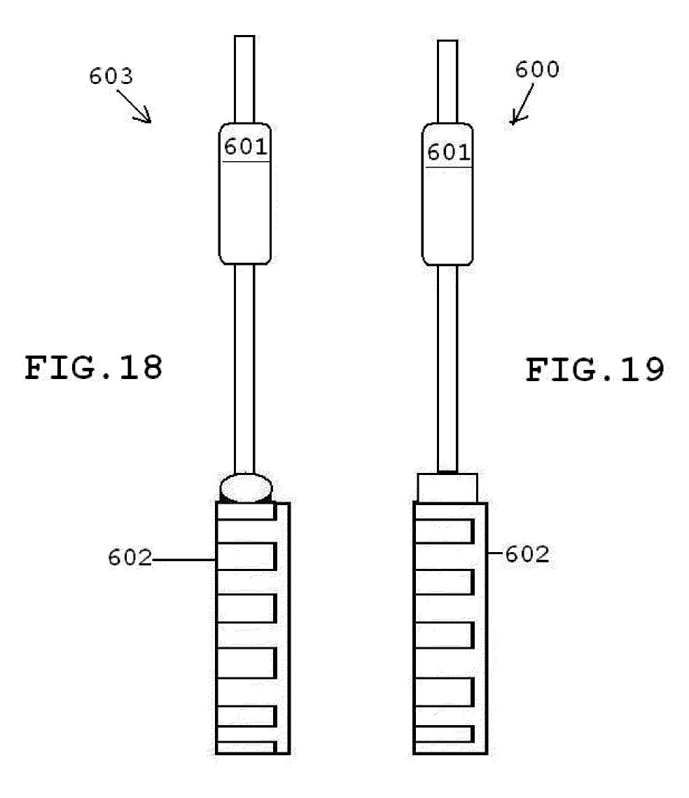

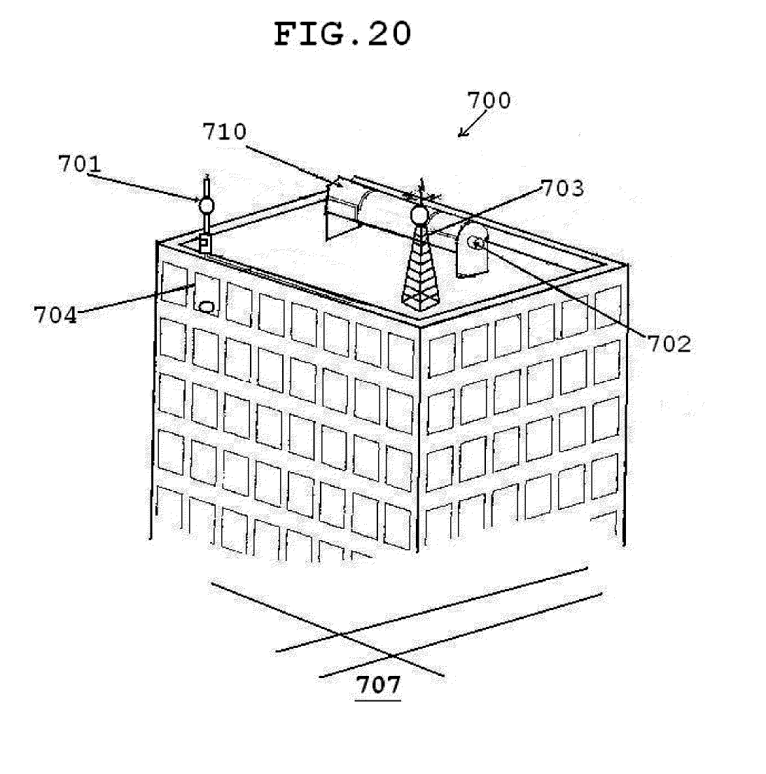

Referencing FIG. 12, Direct Current In (DC IN) 401 is buffered by a gang of capacitors 410 before being communicated to a DC/AC converter 420. The DC/AC converter 420 converts the direct current into a an alternating current suitable for placement over an existing electrical grid 430 such as normally found from a power-plant. FIG. 12 Also illustrates an electrical arrangement suitable for use in charging a battery 440. DC IN 401 is buffered by capacitor 410 bank before entering into a step down transformer 435. Step down transformer 435 reduces the voltage so that the voltage can safely be introduced into battery 440 which is connected to ground 450 at the battery's other pole. In FIG. 12, DC IN 401 is fed into an adjustable rheostat 460 which is controlled by the controller 465 so that the DC OUT 470 falls within a computer 475 monitored and sensor 480 specified range. FIG. 13 Hypothetically, unused energy may be recycled current 501 and/or recaptured by reversing the oscillated spin rotation of devices 51, 100, 120 with the use of a rectifier 502 and Step up transformer 503, returned to grid 430 capacitor 410. This theory lends itself to the concept of positive and negative frequency. FIG. 14-17 Self charging propulsion embodiment of the invention where Da Vinci's ball race 510,512 is combined with a disk cylinder 45 and 513 stack balls 525, conductive rotor 46, 511 tooth gear 515 and piezoelectric molded housing 555. FIGS. 18 & 19 Improvement structures Franklin's lightening rod 600,603 and a molded vibration transducer 601 quasi replicating Vion's tubes and piezoelectric spine stacks capacitor 602 improving Tesla's Atmospheric transmit device. FIG. 20 is an atmospheric receiving building sub station 700 where energy is consumed and excess rendered to the grid 707 by conductive rotor 702 transducer 710, tower transducer 703, antenna rod 701 and transducer windows 704.

FIG. 12 and FIG. 2 flowchart illustration also includes battery 440. Battery 440 may provide electrical power to components of ATS devices within FIG. 11. Charging circuitry may also be provided to charge battery 440 when an external power supply is connected to an ATS device 100. FIG. 14-17 eliminates one or more steps by presenting a self charge retaining transducer 510-513 may be configured with an accelerator sensor 480 controller 465 and gears 515, provide reciprocal power incorporated within piezoelectric molded and ceramic housing 555 along with stack balls 525 and cylinder 545. This assembly more resembles a motor by characteristics given power with application.

In operation, as illustrated in FIGS. 2-20 and FIGS. 21-34, is periodically energized by movement to rotate Orb in either a clockwise or counterclockwise direction. The length of time or activity is energized, and the length of time between the period when the capacitor 31, 102 battery is energized, will depend on the particular ATS device design. As the Orb rotates, the outer end of the disk moves along a 360° circular pathway to push against with forward and rearwardly spinning. Upon engagement of the Orb, ATS device disk is rotated until carried to the apex or top of the circular pathway. Upon reaching the apex, the gravitational and vibrational force or counterweight 50 promotes additional oscillation. ATS device movement rapidly rotate on Orb at a rotational speed greater than the speed of rotation of Orb. Counterweight 50 is then carried beyond the bottom or lowest point of the pathway by its momentum to a point near the apex on the opposite side of the pathway. The cycle is repeated through multiple increasing oscillations of the ATS device until counterweight 50 stops at the bottom position, or until once again engages to again move counterweight to the top of its circular pathway.

FIG. 2 is a flow chart showing generation of energy using a rotor according to one or more of the above-described embodiments. First, battery 27 starts the engine 29 and/or mobile transducer 33 is oscillated. In response to this acceleration, forces are imposed on one or more rotation piezoelectric devices. In response to those forces, the piezoelectric devices output electrical energy, which energy is extracted at a power controller 465. The power controller 465 sensor 480 then makes this energy available to recharge a capacitor 410 battery 440 and/or to electronic components of the mobile terminal. Although FIG. 2 shows a serial flow of events, it is to be appreciated that the events of blocks 33, 27 and 29 occur substantially instantaneously upon acceleration of the mobile terminal.

### Preferred Alternate Embodiments

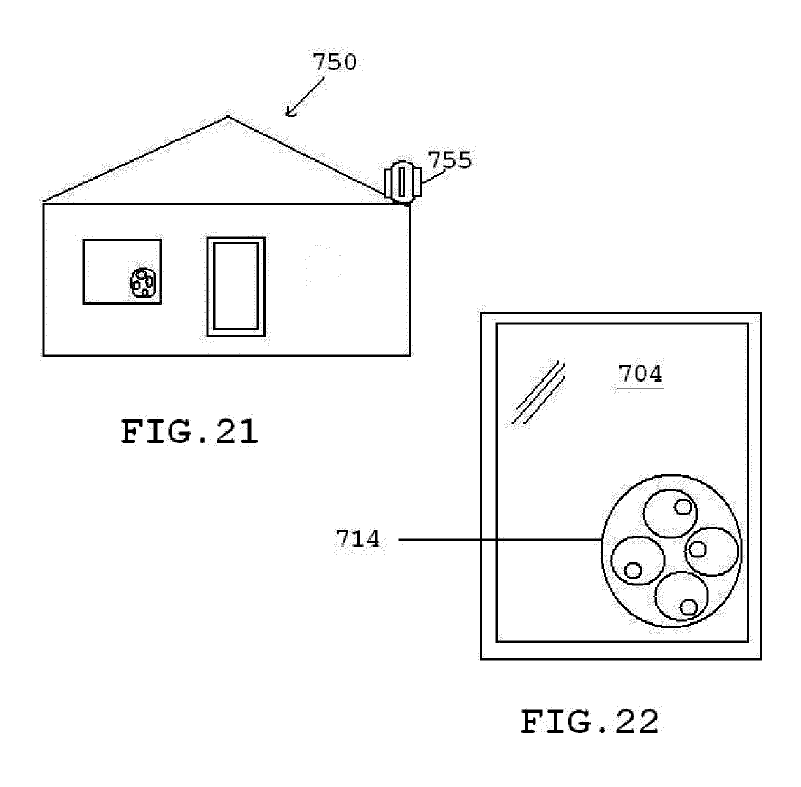

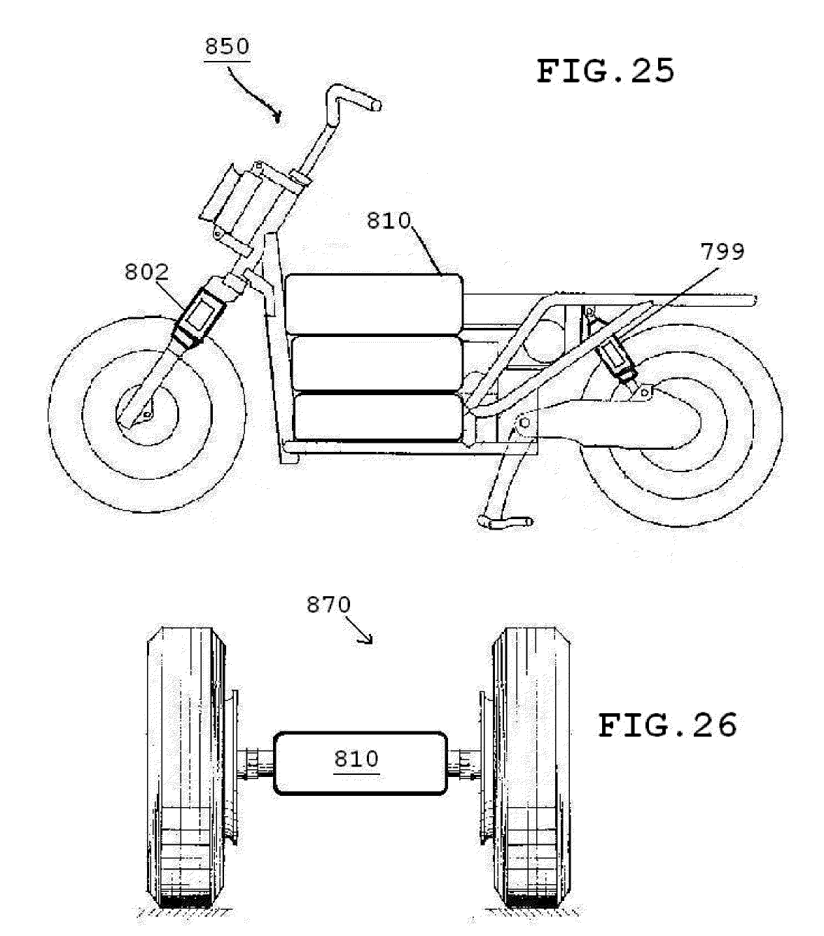

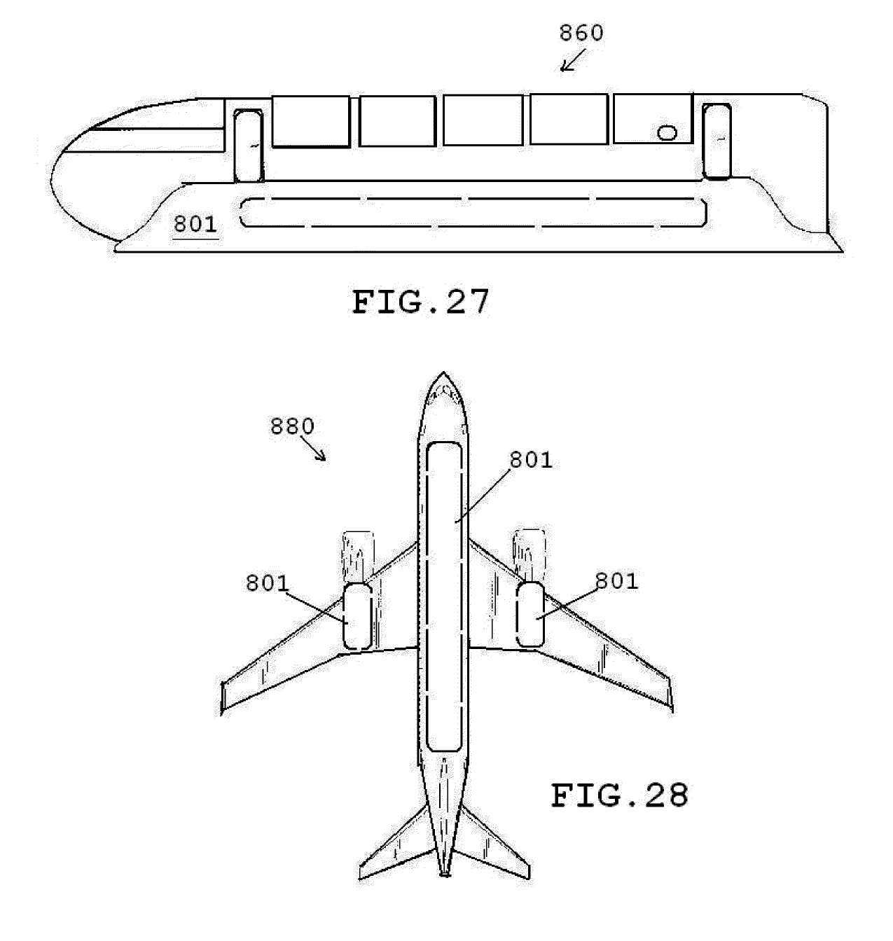

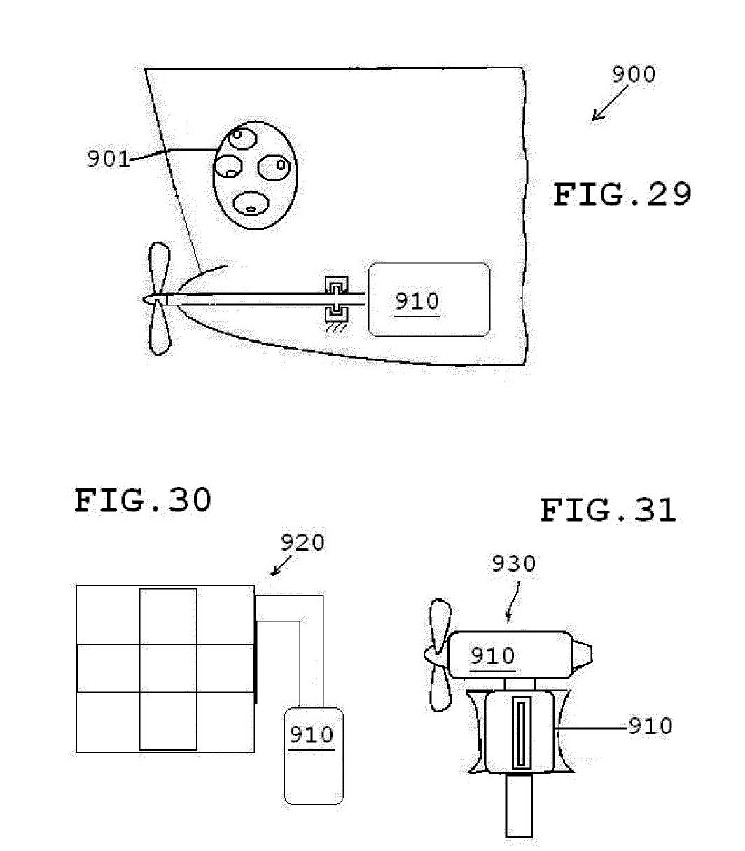

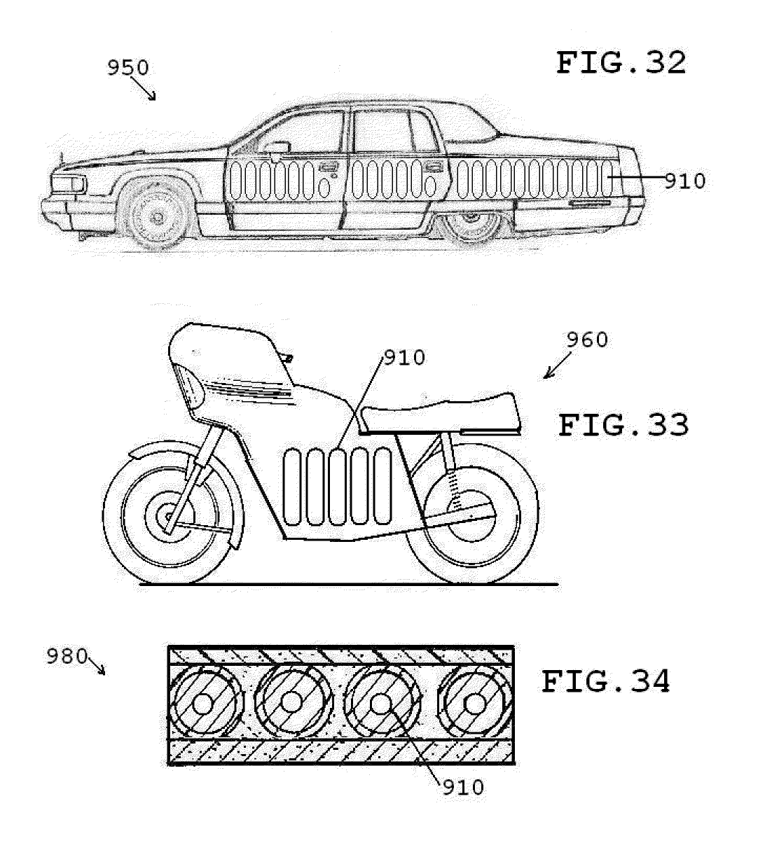

The present invention (ATS) device in accordance with an embodiment of the present invention overcomes the foregoing problem in the conventional art and provides an electro energy vibration and alternative to gas, oil or fossil fuel consumption in FIG. 21 homes 750 transducer 755, FIG. 28 airplane 880 transducer 801, FIG. 27 train 860 transducer 801, FIG. 32 auto 950 transducer 910, FIG. 25 and FIG. 33 motorcycles 960,850 transducers 799, 802, 810, 910 and FIG. 29 boat 900 transducers 901,910.

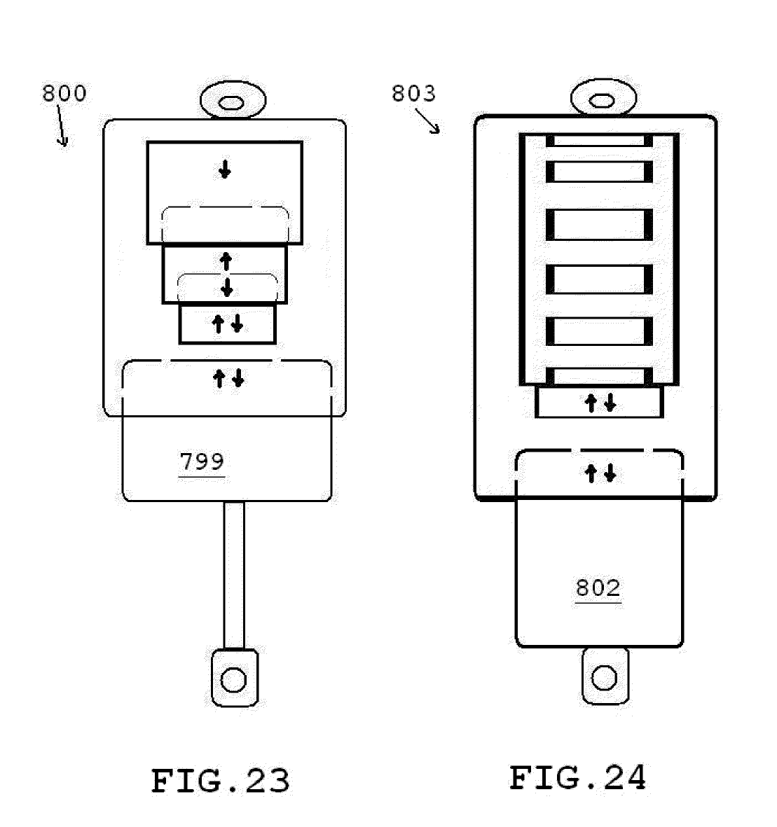

In order to solve the foregoing problems in the conventional art, the present invention provides an electro transducer having a ball bearing assembly which is compatible with FIG. 26 axle shaft 44 transducer 810 wheel 870 assembly. In order to solve the foregoing problems in the conventional art, the present invention provides an electro transducer having an FIG. 34 housing panel 980 transducer 910 assembly which is compatible with an exterior body assembly. Thereby, an Atmospheric transducer device may be shock 800 integrated as within the FIG. 23 coupler 802, and FIG. 24 ladder 799, (vertical friction) piezoelectric absorbers assemblies. In order to solve the foregoing problems in the conventional art, the present invention provides an electro transducer having a capable flat assembly which is compatible with FIG. 22 window 704 disk 31 plate transducer 714, FIG. 30 solar panel 920 transducer 910, FIG. 31 wind turbine 930 transducer 910 assembly. This invention provided FIG. 3 piezoelectric plate disks 31, FIG. 7-10 spine piezoelectric disks stacks 107-110 capacitor 102, FIG. 17 piezoelectric stack balls 525 capacitor, the arrangement of balls 525 will not be in a facing relation. The deformation in the inner and outer races during rotation of the ball bearing while undergoing a radial load is made irregular and complicated. The spine eliminates the deformation and vibration level increased by a combination of ceramic and molded piezoelectric materials at a regular predetermined frequency thereby multiplying the level of vibration and noise reduction.

Certain modifications and improvements will occur to those skilled in the art upon a reading of the foregoing description. It should be understood that all such modifications and improvements have been deleted herein for the sake of conciseness and readability but are properly within the scope of the following claims.

Thus it is seen that an atmospheric transducer device may be integrated and/or provided. It will be understood that the foregoing is only illustrative of the principles of the invention, and that various modifications can be made by those skilled in the art without departing from the scope and spirit of the invention, and the present invention is limited only by the claims that follow.

1-3. (canceled)

4. An atmospheric transduction system comprising:
means for recycle recharge by oscillation and frequency in accumulation of environmental positive and negative electricity, maintaining the voltage being collected in a prescribed range, providing an electrical conversion broadcast network; and
means for collecting the atmospheric electrical power as direct current and then supplies the appropriate power grid, transceiver and capacitates a charge; and
means for self charging propulsion provides motor characteristics, and frequency engine.

5. The atmospheric transduction system in accordance with claim 1, wherein said means for recycle recharge by oscillation and frequency in accumulation of environmental positive and negative electricity, maintaining the voltage being collected in a prescribed range, an electrical conversion broadcast network comprises piezoelectric transducer molded device(s), rotor, stack ball bearing, coupler, book spine stacks and antenna rod stacks;
wherein said means for collecting the atmospheric electrical power as direct current and then supplies the appropriate power grid and capacitates a charge comprises a piezoelectric network, piezoelectric grid, piezoelectric spine stack antenna, piezoelectric transmitters, piezoelectric receivers, piezoelectric devices, piezoelectric cylinders and orbs, power frequency broadcast;
wherein said means for charging providing motor characteristics, said power frequency engine comprises a sensor accelerator, rotor/gear, battery/capacitor, antenna, controller, for propulsion.

6. An atmospheric transduction system comprising:
a piezoelectric transducer molded device(s), rotor, spine ball bearing, coupler and book spine stack transducers, for recycle recharge by oscillation and frequency in accumulation of environmental positive and negative electricity, maintaining the voltage being collected in a prescribed range, providing an electrical conversion broadcast server network; and
a piezoelectric network, piezoelectric grid, piezoelectric spine stack antenna, piezoelectric transmitters, piezoelectric receivers, piezoelectric devices, piezoelectric cylinders and disc orbs, stack rods, power frequency broadcast, for collecting the atmospheric electrical power as direct current and then supplies the appropriate power grid, transceiver and capacitates a charge; and
a sensor accelerator, rotor/gear, battery/capacitor, controller, antenna, means for self charge propulsion providing motor characteristics, thereby an engine of power frequency.
